(19) United States
(12) Patent Application Publication
(10) Pub. No.: US 2011/0159742 A1
(43) Pub. Date: Jun. 30, 2011

(54) STRUCTURE OF BULB SOCKET OF DECORATIVE LIGHT STRING

(76) Inventor: DE-HUI LIN, Zhubei City (TW)

(21) Appl. No.: 12/948,785

(22) Filed: Nov. 18, 2010

Related U.S. Application Data
(63) Continuation-in-part of application No. 12/650,568, filed on Dec. 31, 2009.

(51) Int. Cl. H01R 24/00

(52) U.S. Cl. 439/660

(57) ABSTRACT

Disclosed is a structure of bulb socket of decorative light string. The socket forms an accommodation chamber for accommodating electrical wires. The accommodation chamber has top and bottom walls respectively forming opposing channels. The electrical wires have conductive plates mounted thereto and the conductive plates are insertable, in a vertical condition, through the channels into the accommodation chamber for being subsequently received and retained in retention slots formed inside the accommodation chamber. This allows the operation of assembling the socket and the electrical wires to be performed automatically with machines.

### CROSS-REFERENCE TO RELATED APPLICATION

This is a continuation-in-part of the co-pending patent application Ser. No. 12/650,568, owned by the same applicant.

### (a) TECHNICAL FIELD OF THE INVENTION

The present invention generally relates to an improved structure of bulb socket of decorative light string, and more particularly to an improvement of coupling between a bulb socket and electrical wires.

### (b) DESCRIPTION OF THE PRIOR ART

A known structural arrangement of a bulb socket of a decorative light string and electrical wires is shown in FIGS. 1 and 2. The bulb socket 10 forms an accommodation chamber 11 for accommodating the electrical wires 20 therein. The accommodation chamber 11 has a front end of which left and right side walls forming retention slots 12 for receiving and retaining retention tabs 31 of conductive plates 30 of the electrical wires 20. Assembling operation of the socket 10 and the electrical wires 20 is illustrated in FIG. 3. The retention tabs 31 of the conductive plates 30 of the electrical wires 20 have an overall height that is greater than that of the accommodation chamber 11 but smaller than a width of the accommodation chamber, whereby the conductive plates 30 must be first set in for example a horizontal condition before they can be fit into the accommodation chamber 11, and once passing through the accommodation chamber 11, the conductive plates 30 are rotated to for example a vertical condition and further moved aside. Afterwards, the electrical wires 20 are pulled backward to have the retention tabs 31 of the conductive plates 30 fit into and engaging the retention slots 12.

Since the conductive plates 30 of the electrical wires 20 must be moves through the accommodation chamber 11 in a horizontal condition and then rotated to a vertical condition before they can be fit into the retention slots 12, the assembling operation can only be performed by first setting one electrical wire 20 and then the same performed for another electrical wire 20. Further, such an operation must be performed manually and is not suitable for automatic machines. Thus, the operation is generally time-consuming and labor-consuming and consequently, the manufacturing costs are high. Apparently, further improvement is needed.

### SUMMARY OF THE INVENTION

In view of the problem that bulb sockets and electrical wires of a conventional decorative light string must be assembled with human labor and machine-based automation of the assembling is generally impossible, which makes the assembling operation time-consuming and labor-consuming and thus leads to increased manufacturing costs, the present invention aims to provides a structure of bulb socket of decorative light string that helps eliminating this problem.

The present invention provides an improvement for the assembling of a bulb socket and electrical wires of a decorative light string, wherein an accommodation chamber formed in a bulb socket for accommodating electrical wires forms, in top and bottom walls thereof at locations close to the left-side and right-side retention slots that are provided for receiving and retaining conductive plates mounted to inner ends of the electrical wires, channels that are substantially flush with the retention slots at inner end, so that the channels are respectively and closely adjacent to the retention slots, and each of the channels has a bottom extending inward beyond the inner end of the electrical wire accommodation chamber to define a positioning board. With such an improvement, in assembling the socket and the electrical wires, the conductive plates of the electrical wires can be set in a vertical condition for directly moving from a lower end of the socket through the channels into the accommodation chamber for being subsequently received and retained in the retention slots of the accommodation chamber [symbol] the retention slots. This allows the assembling of the electrical wires and the socket to be performed automatically with machines to thereby reduce the manufacturing costs.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIGS. 1 and 2 show spatial relationship between a conventional bulb socket and electrical wires.

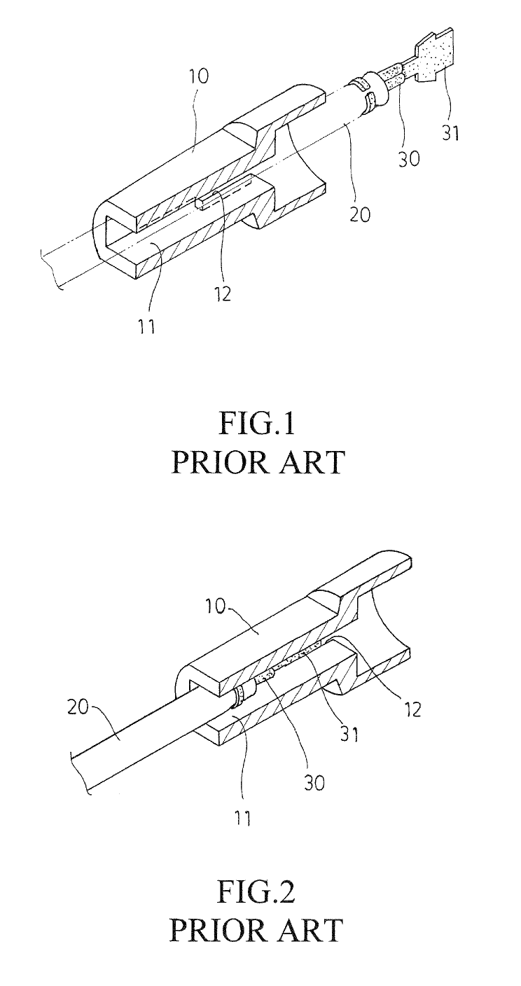

FIG. 3 demonstrates an operation for assembling the conventional socket with the electrical wires.

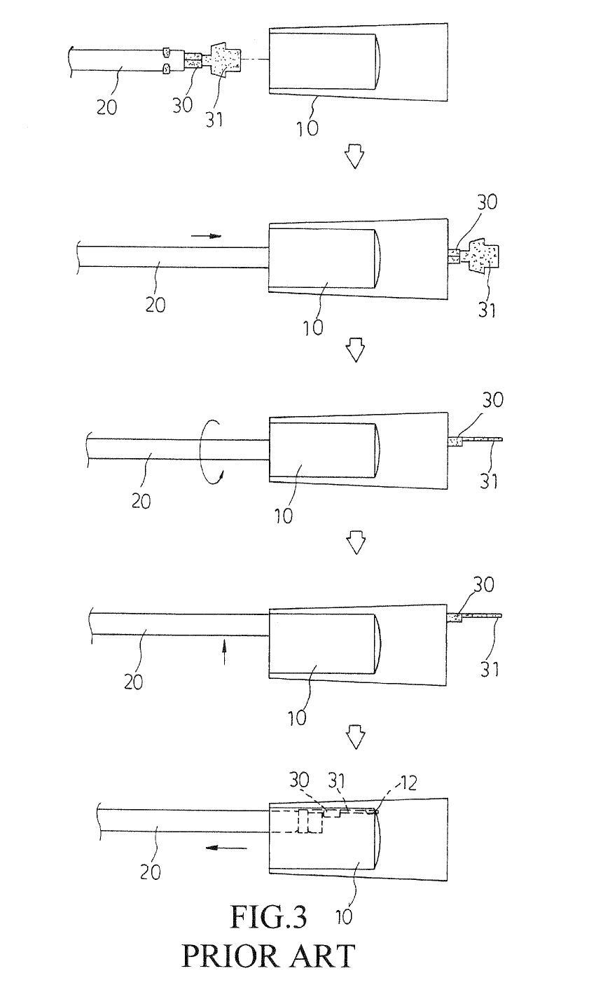

FIGS. 4-6 show spatial relationship between a bulb socket according to the present invention and electrical wires.

FIG. 7 demonstrates an operation for assembling the socket of the present invention with the electrical wires.

FIGS. 8 and 9 schematically show the spatial relationship between the socket of the present invention and the electrical wires.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

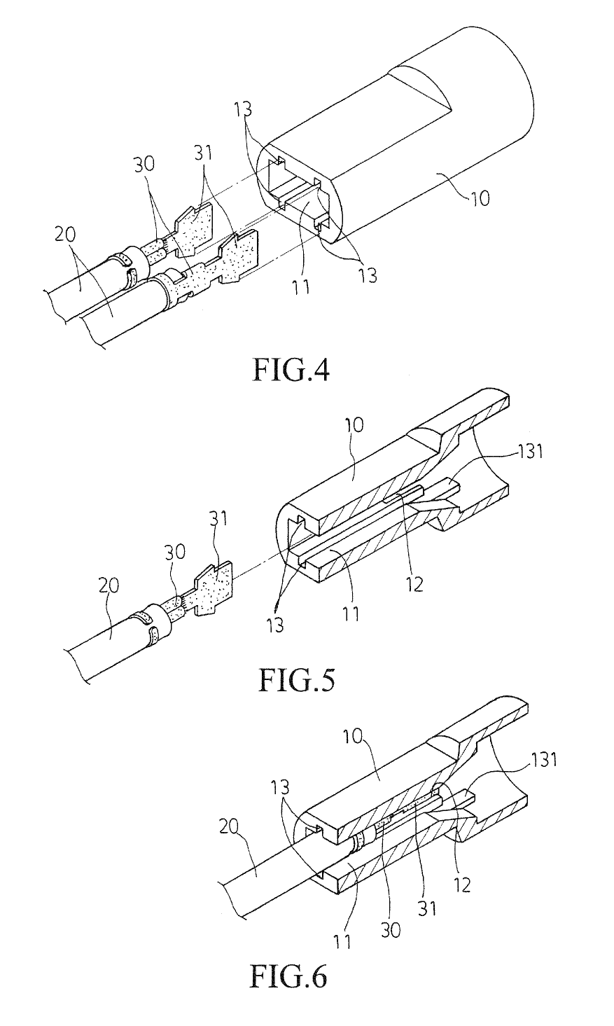

Referring to FIGS. 4-6, the present invention provides a bulb socket 10, which forms an accommodation chamber 11 for accommodating electrical wires 20. The accommodation chamber 11 has an inner end of which opposite side walls respectively form left-side and right-side retention slots 12 for receiving and retaining retention tabs 31 of conductive plates 30 of the electrical wires. The accommodation chamber 11 of the socket 10 also forms, in the top and bottom walls thereof at locations close to the left-side and right-side retention slots 12, channels 13 that are substantially flush with the retention slots 12 at inner end, so that the channels 13 are respectively and closely adjacent to the retention slots 12. Each of the channels 13 has a bottom extending inward beyond the inner end of the electrical wire accommodation chamber 11 to define a positioning board 131.

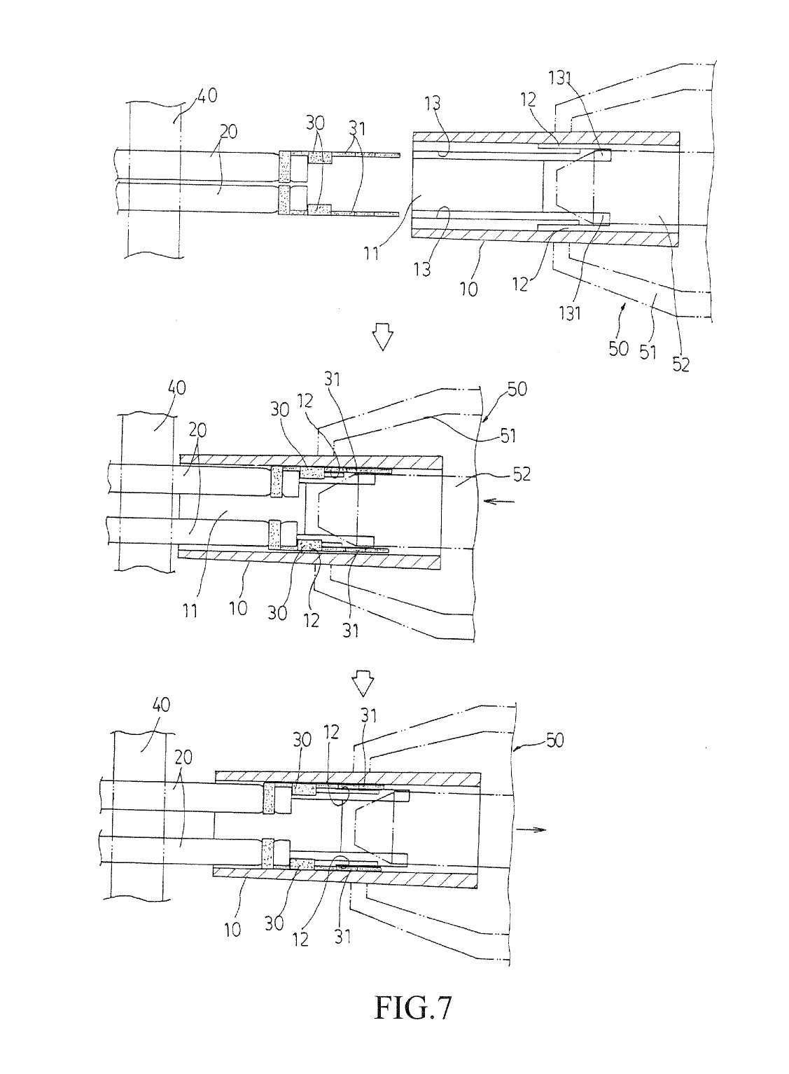

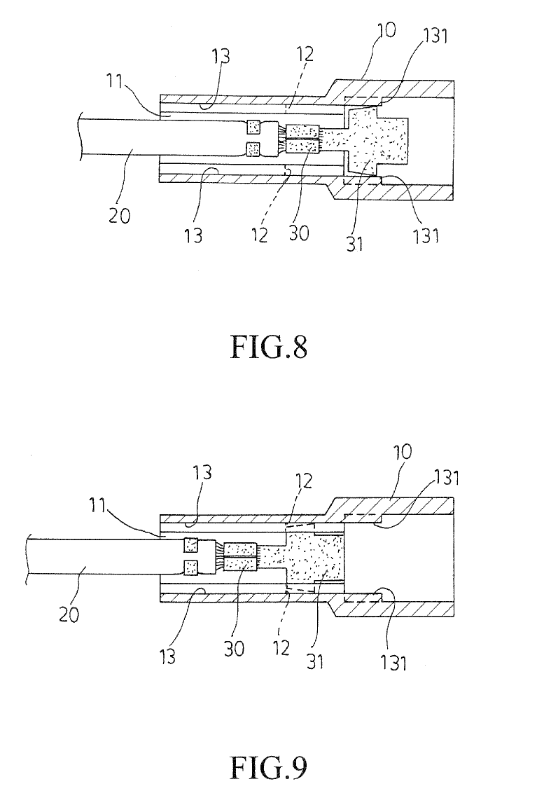

Referring to FIG. 7, assembling of the socket 10 and the electrical wires 20 can be carried out by automatic machines. The electrical wires 20 are handled by a positioning device 40, while the socket 10 is handled by a clamping device 50 that comprises a clamp 51 and a deflection bar 52. The positioning device 40 holds two electrical wires 20 in a vertically positioned manner and set the electrical wires to oppose a socket 10 held by the clamping device 50. The clamping device 50 then moves the socket 10 toward the two electrical wires 20 to have the retention tabs 31 of the conductive plates 30 of the two electrical wires 20 received through the left-side and right-side the channels 13 into the accommodation chamber 11 of the socket 10 for further inward movement. When moved through the channels 13 of the accommodation chamber 11, the retention tabs 31 of the two conductive plates 30 are brought into engagement with and thus sideways deflected by the deflection bar 52 of the clamping device 50 so as to be positioned against left and right side walls and located inward of the retention slots 12. Afterwards, the clamping device 50 slightly moves the socket 10 backward to have the retention tabs 31 of the two conductive plates 30 to fit into and thus engage the retention slots 12, thereby completing the assembling operation of the two electrical wires 20 and the socket 10. Further, as shown in FIGS. 8 and 9, when the retention tabs 31 of the two conductive plates 30 are moved through the channels 13 of the accommodation chamber 11, the positioning boards 131 extending from the bottoms of the channels 13 function to provide subsequently support to the retention tabs 31 of the conductive plates 30 in order to prevent undesired shifting of the conductive plates 30 that might result in misalignment between the retention tabs 31 and the retention slots 12 and eventually affect the assembling operation of the socket 10 and the conductive plates 30. With such an improved structural arrangement, the assembling or coupling between the electrical wires and the socket can be performed with automatic machines, whereby the assembling operation of the electrical wires and the socket is reliable and efficient and thus the manufacturing costs can be reduced.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A bulb socket of decorative light string, the socket forming an accommodation chamber for accommodating electrical wires, the accommodation chamber having an inner end of which opposite side walls respectively form left-side and right-side retention slots for receiving and retaining retention tabs of conductive plates of the electrical wires, the improvement comprising that the accommodation chamber of the socket forms, in top and bottom walls thereof at locations close to the left-side and right-side retention slots, channels that are substantially flush with the retention slots at inner end, so that the channels are respectively and closely adjacent to the retention slots, each of the channels having a bottom extending inward beyond the inner end of the electrical wire accommodation chamber to define a positioning board.
